(19) United States
(12) Patent Application Publication
(10) Pub. No.: US 2007/0006438 A1
(43) Pub. Date: Jan. 11, 2007

(54) Regeneration process for catalytic converters

(76) Inventor: Marco Loiola, Marcon (IT)

Correspondence Address: EGBERT LAW OFFICES, 412 MAIN STREET, 7TH FLOOR, HOUSTON, TX, 77002, US

(21) Appl. No.: 10/557,880

(22) PCT Filed: May 13, 2004
(86) PCT No.: PCT/IT04/00266

§ 371 Date: Nov. 21, 2005

(30) Foreign Application Priority Data
May 22, 2003 (IT) TV2003A000080

(51) Int. Cl. B23P 19/04

(52) U.S. Cl. 29/402.03; 29/890; 29/402.08; 29/402.11

(57) ABSTRACT

This invention describes a method of regenerating run-down or no longer efficient catalytic converters. The converter is cut perpendicularly to its axis in the area where the catalytic unit to be substituted is housed. The internal part of any residue of the catalyst that was inside is emptied and cleaned. The shell of the converter is filled with a helical unit without casing, either made of one smooth and one corrugated metal sheet overlapped and wrapped in a coil and treated after or before with washcoat and precious metals. The coiled bands are secured to the shell. The catalytic converter is reconstituted by joining and tig/mig welding together the two previously separated parts.

This invention describes a method of regenerating run-down catalytic converters.

It's a known fact that cars, industrial vehicles, earthmovers and generally all vehicles with an i. c. engine, are equipped with an exhaust system to eliminate the exhaust fumes, which consists of various parts. In a car for example, the exhaust system is made of:
an exhaust manifold
a catalytic converter (which can be linked or not to the manifold)
the silencer (itself made of different elements)

This invention is only about the catalytic converter.

The vehicles with internal combustion engines are equipped by the manufacturing company with a specific catalytic converter, its characteristics especially depend on the type of engine used.

A catalytic converter is composed of a stainless steel casing, with a steel or cordierite monolith placed inside (catalytic unit), whose use is to destroy the pollutants contained in exhaust fumes.

An example of catalytic unit is described in the patent IT2001A19.

The actual catalytic part, which is enclosed in the steel shell, is linked with welded joints to the rest of the exhaust system (the manifold and the silencer) by fittings, pipes and flange joints, which differ in shape and length.

Each vehicle has its own specific exhaust system and currently there are more than 700 different types of cars, therefore 700 different types of catalysts. To reproduce all the models would be a very costly investment, as they all have to be bought. Each one requires the building of an assembly template and fittings must be recognised and reproduced exactly the same (pipes and flange joints).

To make the models would require an initial investment in equipment plus a further investment for the parts (semi manufactured) in order to allow for their assembly. If the models are more than 700 the parts to be reproduced will be more than 3000. The logistic effort in managing the stock warehouse of the end products and the semi manufactured ones is enormous!

The regeneration of a used converter currently means the substitution of the catalytic block, that is the substitution of the part of the converter, which houses the monolith. In order to avoid modifying the shape(profile) and form, the operation must be done either with the piece still installed on the vehicle or with the piece locked at the two ends on a clamp template. Using a saw or an abrasive disk the catalytic block made of monolith plus its cone fittings is then cut and substituted with a new ceramic or metallic unit Depending on how the work is carried out, the results of the operation may differ. The aesthetic result cannot always be good because the match of the new catalyst isn't always easy, especially when the catalyst and the converter are part of the same block, which may affect its working order.

a mixed converter is obtained with some original parts and other non-original ones often of inferior quality.

the cost of the operation is not always convenient and it depends on how complex the converter is to work on; this affects the cost of labour and consequently, the relationship between quality and price suffers.

The aim of this invention is to propose a simple and cheap way of regenerating exhausted converters (in which the catalyst power has been worn out) and to recondition the ones that are no longer efficient (where the internal monolith is broken or non existent).

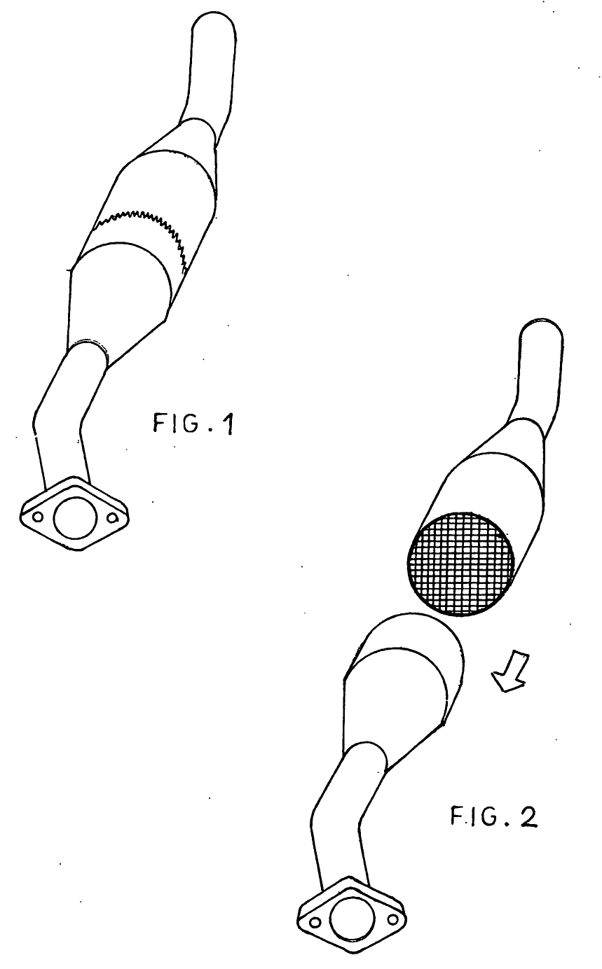

With reference to the attached figures, by using a saw, the run-down catalyst is sectioned on one side perpendicularly to its axis, in a convenient spot either where the section and the shape of the monolith are even or where it's easier to extract its content (FIG. 1).

Alternatively you can make a parallel cut to the axis of the area with the widest cross section.

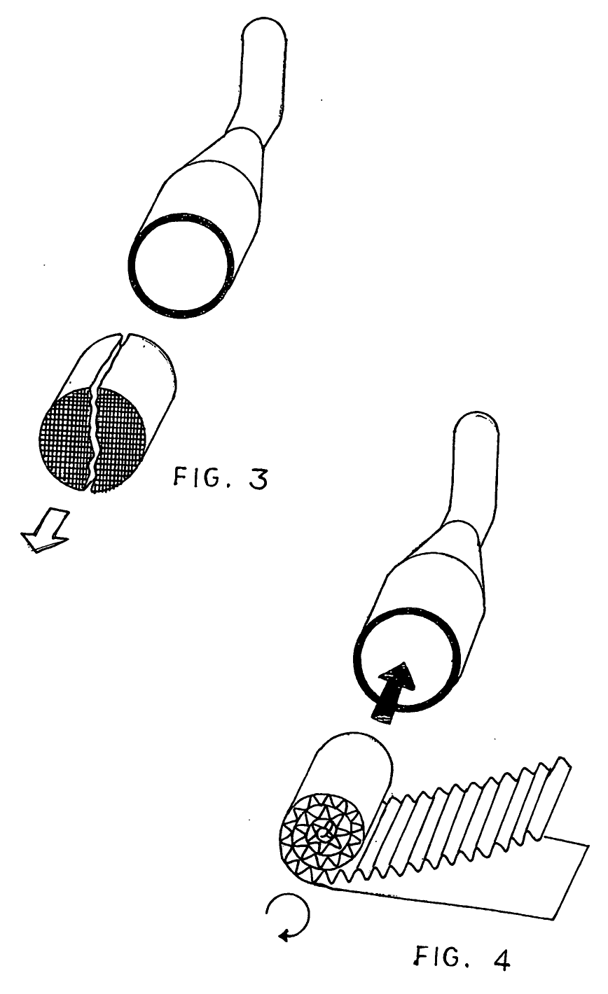

The converter is then emptied completely of its inside components. The ceramic part (the monolith) which may sometimes be broken or partly non existent or the catalytic metallic part is taken out and sent to be recycled (to re-use the precious metals which are still inside) (FIG. 2-3). The inside part is carefully cleaned of any residue and filled with a new catalytic unit obtained by overlapping and coiling two metal sheets, one smooth and one corrugated, both coated in washcoat and permeated with other noble metals following well-known techniques. (FIG. 4) A variation on this method could be done by inserting in the casing a coiled unit (starting with) bands treated only with washcoat, which will then be permeated with precious metals.

For reference there is a lot of easily accessible literature about the concept of coiled unit and its preparations.

The new catalyst unit is then fixed to the original casing with a number of pins, rivets, rods or fittings (FIG. 5). The coiled bands must be prevented from rotating and moving with respect to the converter axis.

Alternatively, once recognized the exact internal form of the casing you can calander a thin steel plate of the right longitudinal dimension (so as to be compatible with the dimension of the casing) and fill it with a coiled unit staring with smooth and corrugated steel bands treated with washcoat following the procedure illustrated in the patent IT2001A19. In the latter case, the regeneration is done by using a prefabricated catalytic unit which is then inserted in the emptied casing of the original converter and then secured by spot welding it to the casing itself.

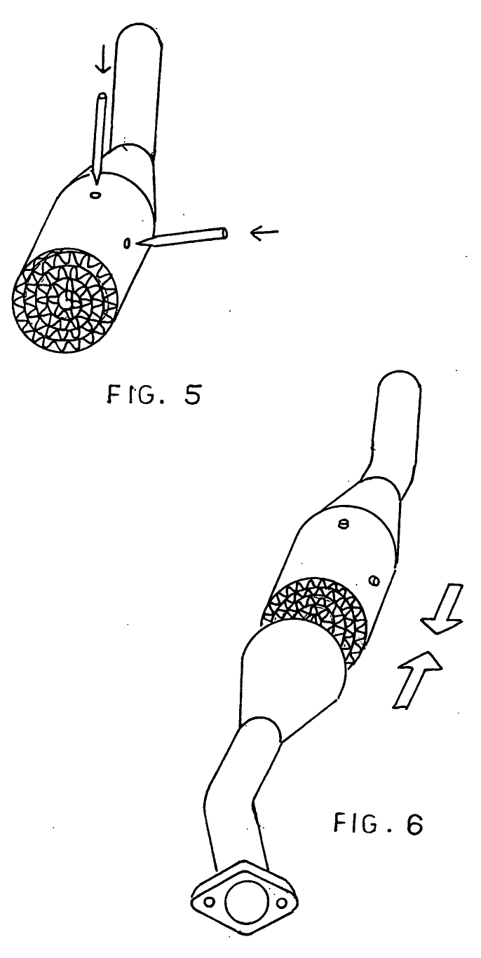

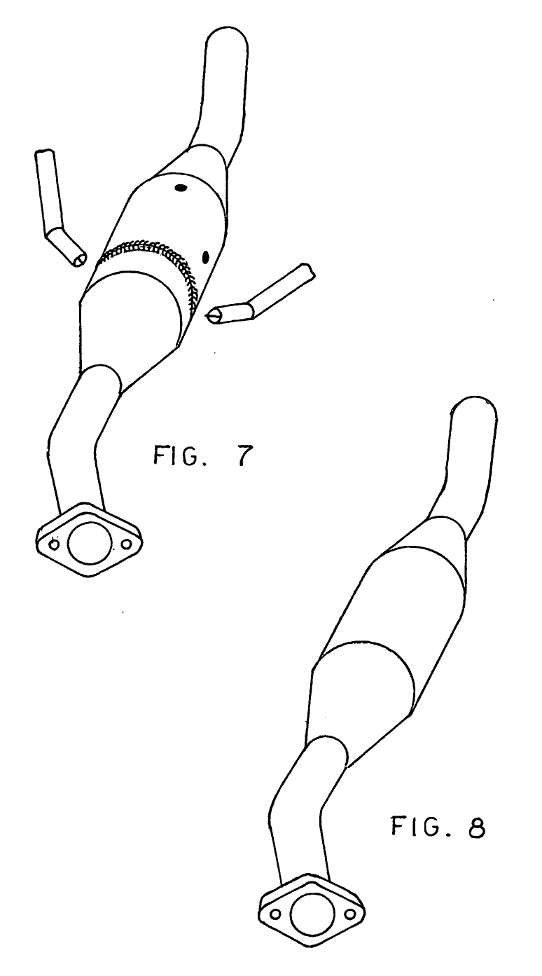

Once fitted, if the procedure hasn't initially been carried out on the bands, the new coiled unit has to be permeated with precious metals on the basis of well-known procedures. After the thermal treatment (which is only necessary if the permeating procedure is carried out at this stage), the converter is closed, that means the parts which were separated initially, are joined and welded together. (FIG. 6-7)

The welding can be done either with a continuous electrode welder or with a TIG welder. By using the latter, the aesthetic result will be definitely better as there will be no trace left of the join.

Lastly the converter is finely sanded in order to eliminate the oxide on the surface. This operation is optional and gives back the piece its original shine.

The advantage of this technique is obvious.

There is no need to build templates, specific parts, flange joints or spare parts, because the work is carried out on the original piece which is still in excellent condition as it is made of high quality stainless steel;

The reconditioning, that is the regeneration of the converter, only requires catalytic bands of standard production (with two or three sizes all converters can be overhauled) or at the most catalytic units of standard form and dimension.

The reconditioning transforms the original ceramic piece at 400 cpsi (cells per square inch) into a steel indestructible converter, which cannot be broken (while ceramic is very fragile). After all the regeneration with a ceramic monolith is very difficult to carry out and the result is uneconomic as ceramic catalytic units are both rigid and fragile.

The new catalyst can be made using bands of 400 cpsi but also of 200 and 100 cpsi and generally bands of any number of cells. It is well known that by varying the number of cells the opposite resistance of the catalyser changes when the gases pass through and consequently the engine performance changes. This technique can be favourable also in case of sports cars. It's possible to regenerate the catalyst by either returning to its original operational features or by giving it higher sports specifications in terms of performance.

By permeating the coiled unit after inserting it into the casing, precious metals are saved, therefore costs are reduced. As the work is being done on bands which have already been treated, loss of material is avoided both during the gauging of the coiled unit to be inserted and during the drilling for the positioning of the pins.

The process is quick and at the end of the work, if the weld has been done well, there will be no trace of the join. It can also be used for catalysts of any shape (round, oval, trapezoidal etc)

The present invenction is open to many modifications, all of which are a part of the inventive concept

Technical details can be substituted by other technically equivalent elements.

Any materials can be used, depending on the requirements, so long as they are compatible with the necessary use.

I claim:

1. A regeneration method of run-down or no longer efficient catalytic converters, said regeneration method comprising the steps of:
cutting a converter perpendicularly to an axis thereof in an area where a catalytic unit is housed, in a spot where a cross section of the converter and shape of catalytic unit are even;
emptying and cleaning an internal part of any residue of the catalytic unit that was inside the converter;
filling a shell of the converter with a helical unit without a casing, comprised of one smooth and one corrugated metal sheet overlapped and wrapped in a coil or a pre-manufactured catalytic unit;
securing coiled bands to the shell or fixing the pre-manufactured catalytic unit; and
reconstituting the converter by joining and tig/mig welding two previously separated parts of the converter together.

2. The regeneration method of catalytic converters according to claim 1, wherein said step of cutting the converter is parallel to the axis thereof and at a point where the cross section of the converter is largest.

3. The regeneration method of catalytic converters according to claim 1, wherein said coiled bands form a coiled unit, said coiled band being treated with washcoat and permeated with precious metals both before and after being coiled together and fitted inside the shell.

4. The regeneration method of catalytic converters according to claim 1, wherein said coiled bands form a coiled unit, said coiled band being first treated with washcoat before being coiled and permeated with precious metals after being fixed in the shell.

5. The regeneration method of catalytic converters according to claim 1, wherein said catalyst units have any form or dimension.

6. The regeneration method of catalytic converters according to claim 1, wherein the overlapped and coiled bands are fixed to the shells with pins, rivets and other fittings.

7. The regeneration method of catalytic converters according to claim 1, wherein said catalytic converter has a generic shape used to purify pollutant gases produced by internal combustion engines.
